(19) United States
(12) Patent Application Publication
(10) Pub. No.: US 2018/0227053 A1
(43) Pub. Date: Aug. 9, 2018

(54) SYSTEM AND METHOD OF COMMUNICATING BETWEEN VEHICLES WITH LIGHT FIDELITY MODULE

(71) Applicants: Kuo-Ching CHIANG, New Taipei City (TW); Yi-Chuan CHENG, Changhua County (TW)

(72) Inventors: Kuo-Ching CHIANG, New Taipei City (TW); Yi-Chuan CHENG, Changhua County (TW)

(21) Appl. No.: 15/947,863

(22) Filed: Apr. 8, 2018

Related U.S. Application Data
(63) Continuation-in-part of application No. 15/266,937, filed on Sep. 15, 2016.

(51) Int. Cl. H04B 10/116; H04W 4/46

(52) U.S. Cl. CPC H04B 10/116; G06K 9/00825; H04W 4/46

(57) ABSTRACT

A vehicle comprises a control unit, a light fidelity module coupled to the control unit, wherein the light fidelity module is used for transmitting a visible light to another vehicle and receiving a visible light from another vehicle; and a digital code processing unit coupled to the control unit, wherein the digital code processing unit is used for encoding or decoding data transmitted to or received from the light fidelity module.

### CROSS REFERENCE TO RELATED APPLICATION

This present application is a continuation-in-part of U.S. patent application Ser. No. 15/226,937, filed on Aug. 3, 2016, the present application is based on, and claims priority from above-mentioned application.

### TECHNICAL FIELD

The present invention generally relates to vehicle's communication, in particular, to a system and method of communicating between vehicles with light fidelity module for data exchanging between the vehicles.

### DESCRIPTION OF RELATED ART

Because of the development of the information technology (IT), the information could be exchanged with higher capacity and faster speed. Internet is designed as an open structure to exchange information freely without restriction. The third generation mobile phone standard allows the user access video communication through air. Thus, certain communication service requiring real time information exchange, such as viewing live video, has become feasible through mobile phone communication network or Internet. Cellular communications systems typically include multiple base stations for communicating with mobile stations in various geographical transmission areas. Each base station provides an interface between the mobile station and a telecommunications network. Mobile telephone systems are in use or being developed in which the geographic coverage area of the system is divided into smaller separate cells, it communicates with the network via a fixed station located in the cell. Mobile telephones belonging to the system are free to travel from one cell to another. When a subscriber within the same system or within an external system wishes to call a mobile subscriber within this system, the network must have information on the actual location of the mobile telephone. In pace with the development of information and computer technology, the electronic products grow rapidly with the trend of small size, multifunction and high operation speed. Based on the development of cellular integration technology, communication systems have also been introduced to allow users obtain information more convenient. Thus, the business accompanied with the communication device flourish as well due to the development of the communication technology. The internet and communication service providers also offer business services to assist clients to transfer information or extend the market. The cellular manufactures have to release new models with different appearances, function and styles more frequently so as to attract the attention of the buyer and occupy a favorable marketing share. Communication services providers or information services providers also have to provide diverse, comprehensive and latest information to clients. The demand for voice and mainly high end data services like VOIP, video calling, instant messaging by the user is rapidly increasing as the consumer needs better and efficient ways of transferring data which are large and often need a high level of encryption. The existing radio spectrum fails to cater this burgeoning need and faces various other issues like scalability and availability.

Typically vehicle uses the rearview mirror to monitor the rear view or the traffic condition. The driver has to turn his head to the left rearview mirror or the rights rear view mirror to check the traffic situation, frequently. However, there are blind spots that cannot be seen from the driver position. Further, during conditions of rainfall, the moisture or fog on the windshield may reduce the visible conditions. It will lead to the traffic accident. Unfortunately, there is no efficient way to solve the problem at present. Additionally, traffic conditions may vary rapidly. As a result, during such conditions, the driver must frequently remove the moisture by manual, which can be cumbersome. Current solution includes a magneto-resistive sensor located on a vehicle, upon sensing an object generates an object detection signal. However, the warning system cannot provide the actual situation to the driver.

Therefore, what is desired is to provide an improved communicating system. The improved system may increase reaction time and decrease the probability of a collision, efficiently.

### SUMMARY

A mobile phone comprises a control unit, a visible light source configured to transmit a first visible light to another mobile phone, wherein the visible light source module includes a rear light source or a front light source; a photo detector adapted to receive the visible light transmitted from another mobile phone; and a visible light digital code processing unit coupled to the control unit, wherein the visible light digital code processing unit is used for encoding or decoding transmitted to or received data.

According to an aspect of the invention, the visible light source includes a display back light source. The visible light source includes LED, OLED, field emission or laser device. The mobile phone further includes a visible light driver and a signal amplification and processing unit. Aforementioned mobile phone further comprises a memory, a display, an image capturing device, a wireless data transferring module which coupled to the control unit. The mobile phone further comprises an Internet communication module, a transceiver which coupled to the control unit.

According to an aspect of the invention, a vehicle comprises a visible light source to transmit a first visible light to another vehicle; a photo detector configured to receive a second visible light transmitted from another vehicle; and a digital code processing unit configured to encode the first visible light or decode the second visible light.

According to another aspect of the invention, a vehicle comprises a first visible light source to transmit a first visible light to another vehicle; a roadway light photo detector configured to receive a second visible light transmitted from a roadway light device with a second visible light source; and a digital code processing unit configured to encode the first visible light or decode the second visible light.

According to an aspect of the invention, a vehicle comprises a visible light source to transmit a first visible light to another vehicle; a traffic signal photo detector configured to receive a second visible light transmitted from a traffic signal light device with a second visible light source; and a digital code processing unit configured to encode the first visible light or decode the second visible light.

### BRIEF DESCRIPTION OF THE DRAWINGS

FIG. 1 shows the functional diagram of the present invention.

FIG. 2 shows the functional diagram of the present invention.

FIG. 3 shows the embodiment of the present invention.

FIG. 4 is a top diagrammatic view of the vehicle in accordance with the present invention.

FIG. 5 shows top diagrammatic view of the vehicle in accordance with the present invention.

FIG. 6 shows the functional diagram of a vehicle in accordance with the present invention.

FIG. 7 shows a light communication between the vehicles in accordance with the present invention.

FIG. 8 shows a light communication between the vehicles in accordance with the present invention.

FIG. 9 shows a light communication between a vehicle and roadway light devices in accordance with the present invention.

FIG. 10 shows a light communication between a vehicle and traffic signal light devices in accordance with the present invention.

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

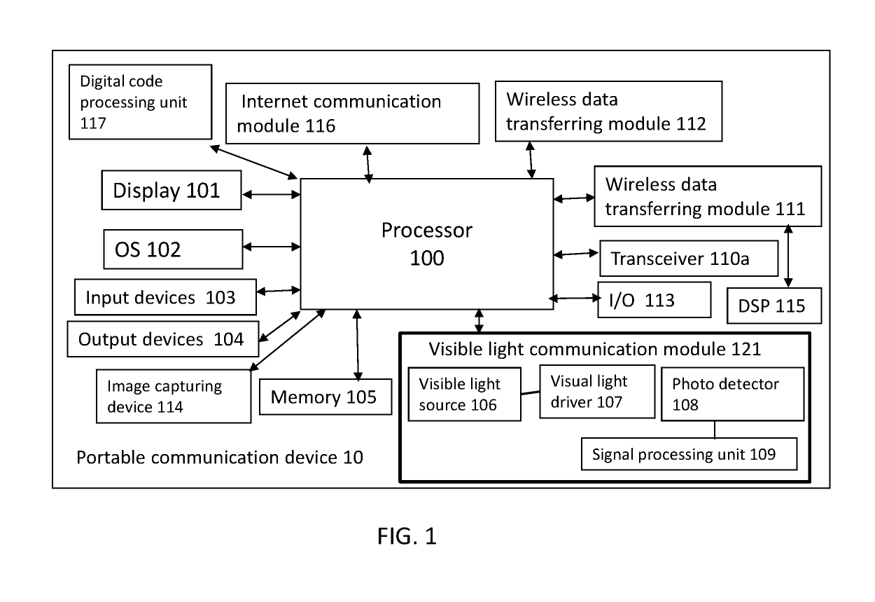

FIG. 1 is a functional diagram depicting an exemplary portable communication device 10 including a variety of optional hardware and software components. Any components in the mobile device can communicate with any other component, although not all connections are shown, for ease of illustration. The portable communication device 10 can be any of a variety of computing devices (e.g., cell phone, smart phone, Personal Digital Assistant (PDA), tablet etc.) and can allow wireless two-way communications with one or more mobile communications networks, such as a cellular or satellite network, and two-way light communication between the portable communication device 10 and others portable communication devices. Moreover, some or all of the components in the portable communication device 10 may be embedded in, coupled to or incorporated in a vehicle, a traffic signal light device, a street light device or a roadway light device.

The illustrated portable communication device 10 can include a controller (control IC) or processor 100 (e.g., signal processor, microprocessor, ASIC, or other control and processing logic circuitry) for performing such tasks as signal coding, data processing, input/output processing, power control, and/or other functions. An operating system (OS) 102 can control the allocation and usage of the components and support for one or more application programs, which can include common mobile computing applications (e.g., email applications, calendars, contact managers, web browsers, messaging applications), or any other computing application.

The illustrated portable communication device 10 can include memory 105 which can include non-removable memory and/or removable memory. The non-removable memory can include RAM, ROM, flash memory, a hard disk, or other well-known memory storage technologies. The removable memory can include flash memory or a Subscriber Identity Module (SIM) card, which is well known in GSM communication systems, or other well-known memory storage technologies, such as “smart cards”. The memory can be used for storing data and/or code for running the operating system 102 and the applications. Example data can include web pages, text, images, sound files, video data, or other data sets to be sent to and/or received from one or more network servers or other devices via one or more wired or wireless networks. The memory can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

The portable communication device 10 can support one or more input devices 103, such as a touch screen, camera, microphone and keypads, and one or more output devices 104, such as a speaker and a display 101. Some devices can serve more than one input/output function. For example, the touch screen and the display 101 can be combined in a single input/output device. The touch screen can support multiple functional icons. The icons can be displayed on a home (touch) screen, which is typically the screen displayed when the portable device is powered on. The home screen is the base screen that generally cannot be further minimized and that contains icons representing applications. As further described below, each icon is represented by an image based on its respective application.

The portable communication device 10 includes at least one wireless data transferring module 111. The wireless data transferring module 111 could be RF module to transmit or receive mobile phone signal, which includes audio data, video data, image data, text data and the combination thereof. As known in the art, the RF module is coupled to an antenna system. The RF module may include base band processor and so on. This antenna is connected to a transceiver, which is used to receive and transmit signal. The wireless data transferring module 111 is compatible to the mobile phone protocol such as W-CDMA CDMA2000 CDMA2001 TD-CDMA TD-SCDMA UWC-136 DECT 4G system. There systems allow the user communicates with video communication. The RF module may perform the function of signal transmitting and receiving, frequency synthesizing, base-band processing and digital signal processing. The SIM card hardware interface is used for receiving a SIM card. Finally, the signal is send to the final actuators, i.e. a vocal I/O unit 113 including a loudspeaker and a microphone. The module 111 can be formed by separated module (chip) or integrated chip. A wireless data transferring module 111 can be coupled to an antenna and can support two-way communications between the processor 100 and external devices, as is well understood in the art.

The device 10 further includes the second wireless data transferring module 112. In one embodiment, a wireless local area network (WLAN) module is employed and it could be compatible to the local area network protocol or standard such as Bluetooth standard, Wi-Fi standard, or 802.11x (x refers to a, b, g, n) standard compatible module. Further, the wireless local area network (WLAN) module could be compatible to the WiMAX (Worldwide Interoperability for Microwave Access) standard or specification. An Internet communication module 116 are coupled to the central control unit 100 to allow transmit and receive the audio, video or both type signal to/from the internet network through the wireless local area wireless transmission module. Internet communication module 116 at least meets the standard of terminal-terminal Voice Over Internet Protocol (VoIP). One of the examples is Skype compatible protocol. By using of the Internet communication module 116 and the wireless local area network module, the user may portably, synchronously transmit and receive the vocal, video or both signal through the internet by using the internet (software) communication module 116. The present invention defines a hand-held device having VoIP phone module and wireless WiFi or WiMax network linking module coupled to the VoIP phone module to allow the user to make a wireless terminal-terminal VoIP phone without power on the PC. The voice over internet protocol (VoIP) phone module is used to encode or convert the voice signal into VoIP protocol within the portable communication device before transmitting the signal, followed by programming the signal into WiFi or WiMax format in order to transmit the voice signal through the wireless network, especially, the Skype phone.

The portable communication device 10 can further include at least one input/output port, a power supply, a satellite navigation system receiver, such as a Global Positioning System (GPS) receiver, an accelerometer, and/or a physical connector, which can be a USB port, IEEE 1394 (FireWire) port, and/or RS-232 port. The illustrated components are not required or all-inclusive, as any components can be deleted and other components can be added. For example, the device 10 may include DSP (digital signal processor) 115, A/D converter (not shown) and a transceiver (receiver and transmitter) 110a.

An image capturing module 114 is required and coupled to the central control unit 100 to catch the video image if the user would like to conduct the real-time video transmission. The image capturing module 114 could be digital still camera, digital video camera. Therefore, the real-time portable conference is possible. The image capturing module 114 includes CMOS or CDD. Pluralities of micro-lens are configured over the CMOS or CCD. In another embodiment, the one difference is that the device may omit the RF module. If the device 10 includes 3G or higher level RF module, the user may transmit the video phone through the air. Therefore, the user may select one of the schemes to make a video call through internet or air depending on the user demand If the device is within the hot spot area, the user may choose the usage of the internet phone module for communication due to cheaper transmitting fee. If the out of the hot spot range, the other option for video communication is provided. Typically, the WCDMA signal is less restricted by the geography limitation, but the transmission fee is higher. The present invention allows the user to select the proper wireless module for video communication. If the user would like to conduct the video communication through WiFi or WiMax, the method includes coupling to internet or hot spot, followed by activating the internet (software) phone module. Subsequently, vocal signal is input from the speaker and image data is captured from the image capture device, subsequently, the image data and the vocal signal are converted from signal to digital. After the conversion, the image data and the vocal signal are composition, compressed or processed to form a data streams.

The device 10 also includes a digital code processing unit or CODEC (coder/decoder) 117 coupled to the processor 100. The digital code processing unit 117 may process and decode or encode the data transmitted to or received from the light fidelity module 121. The data is encoded or decoded in the light signal which is received or transmitted. The device includes but not limited to cellular phone, PDA (personal digital assistant), smart phone, notebook, digital still camera, digital video camera, medium player (MP3, MP4), GPS and the equivalent thereof.

The device 10 further includes a visible light communication device (module) 121 coupled to the processor 100. In one case, the visible light communication device or module 121 is a light fidelity device (module). The visible light communication device 121 is a bidirectional, high-speed and fully networked wireless communication technology, and is a form of visible light communication and a subset of optical wireless communications and could be a complement to RF communication (Wi-Fi or cellular networks), it may be employed for data broadcasting. The visible light communication device 121 uses visible light for transmitting data. The visible light spectrum is 10,000 times larger than the entire radio frequency spectrum. The optical orthogonal frequency-division multiplexing (O-OFDM) modulation methods have been optimized for data rates.

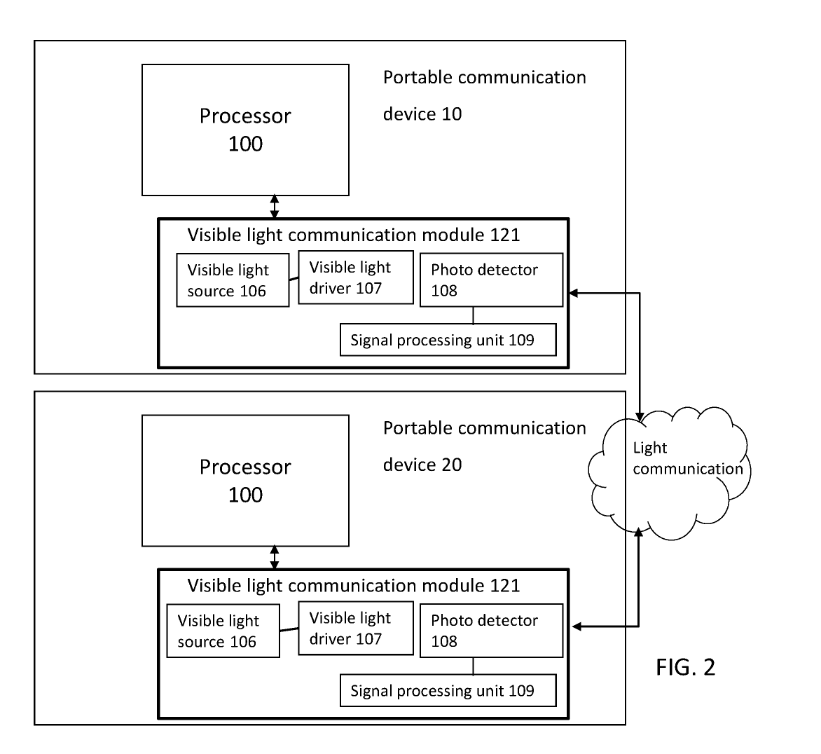

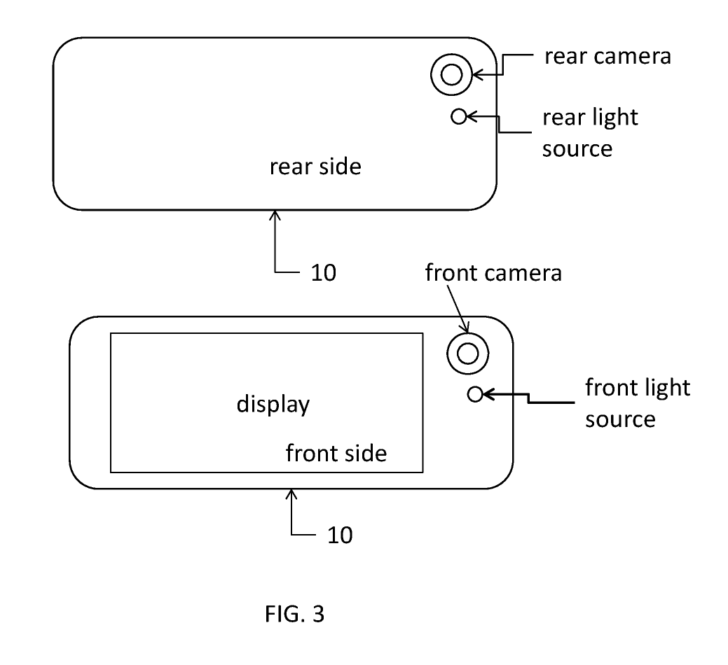

In the present invention, the visible light communication device or module 121 includes at least one visible light source 106, for example, OLED light source, LED light source, field emission light source or laser device, a light driver 107, a photo detector 108, and a signal amplification and processing unit 109. The visible light source 106 is driven by the light driver 107. In one example, the visible light source 106 is a rear light source or a front light source for a rear camera or a front camera, shown in FIG. 3. In another example, the visible light source 106 is a display back light source, please refer to FIG. 3. Data may be encoded in the light by varying the rate at which the visible light source flicker (for example, LEDs flicker) on and off to give different strings of 1s and 0s (logical value). In one example, if the visible light source is on, a digital 1 is transmitted; and if the visible light source is off, a digital 0 is transmitted. The visible light source (for example, LED, OLED, field emission light source, and laser) can be switched on and off very quickly, which gives nice opportunities for transmitting data. It is required that some visible light source and a controller that code data into those visible light. It has to do is to vary the rate at which the visible light source flicker depending upon the data we want to encode. The visible light source (for example LED) intensity is modulated so rapidly that human eyes cannot notice, so the output appears constant. The visible light source device 106 of the portable communication device 10 can stream data embedded in its light beams at ultra-high speed to the photo detector 108 of another portable communication device 20, shown in FIG. 2. Similarly, the LEDs device 106 of the portable communication device 20 can stream data embedded in its light beams at ultra-high speed to the photo detector 108 of another portable communication device 10, shown in FIG. 2. Namely, the photo detector 108 of the portable communication device 10 may receive the data from the portable communication device 20. Thus, the portable communication device 10 can exchange data with the portable communication device 20 by the light fidelity module 121. The photo detector 108 converts light signals into voltage or current. For example, the photo detector 108 of the portable communication device 20 is converting the tiny change in amplitude of the light beams into an electrical current signal, and then converting back into a data stream by the signal amplification and processing unit 109. For example, the signal amplification and processing unit 109 is a transimpedance amplifier (TIA) which is a current-to-voltage converter, most often implemented using an operational amplifier. The TIA can be used to amplify the current output of the photo detectors 108 (such as photodiodes) or other types of sensors to a usable voltage. There is a method of parallel data transmission using array of LEDs, where each LED transmits a different data stream. Another method is using mixtures of red, green and blue LED (or OLED, field emission light source, laser) to alter the light's frequency, with each frequency encoding a different data channel. Such advancements promise a theoretical speed of 1 Gbps, which means one can download a full high-definition film in just 30 seconds.

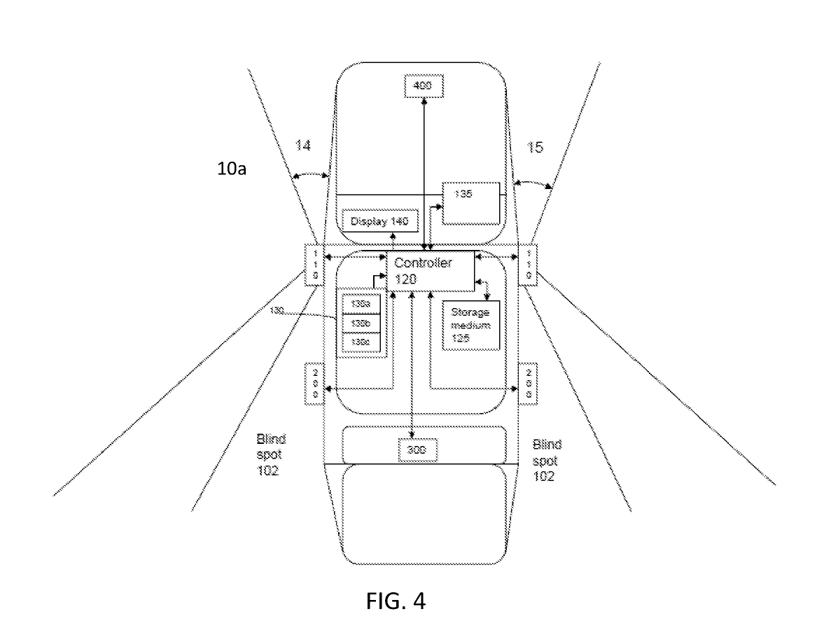

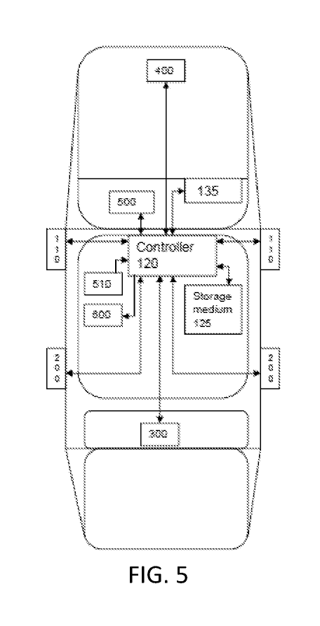

Referring now to FIGS. 4 and 5, the vehicle 10a includes a visual safety system, in accordance with one embodiment of the present invention. Representations of blind spots 102, 14 and 15 are illustrated. The blind spots 102 are the areas beyond which the conventional external rear-view mirrors cannot see without requiring the driver to glance back. The blind spots 102, 14, 15 areas may be changed depending on the mirror size and viewing angle of the driver. One aspect of the present invention is that the vehicle 10a includes at least two image sensors or video camera (such as digital video camera) 110 located on the original rearview mirrors location of the vehicle. In one preferred embodiment, the two rearview image sensors or video camera 110 could replace the function of the conventional rearview mirrors.

Referring now to FIG. 4, a block diagram of the system is illustrated. The system includes a controller 120 processing signals from the vehicle image sensor. The digital external rearview image sensors 110 according to this embodiment comprise a CCD (charge couple device imaging means) or CMOS image sensor for imaging a still or motion picture image and are coupled to the processor. A storage medium 125 that stores still or motion picture image data obtained by the imaging sensor 110 is coupled to the processor 120. The storage medium 125 includes but not limited to hard disc, semiconductor memory, flash drive, flexible disk (such as memory card) or the combination thereof. An operation interface 130 comprising a shutter button 130a and an operation switch group 130b. The operation switch group 130b comprises buttons including a playback switch, recording switch and zoom-in and zoom-out switches. The function is provided to allow the driver or user to zoom-in or zoom-out the displayed image caught by the CCD or CMOS sensor. These functions are well-known in the field of digital video. A wireless inter-vehicle communication module 135 is used for establishing communication with external vehicles. The processor 120 could be GPU, CPU for centrally controlling respective sections of the digital video system of the vehicle 10a. A switch 130c is provided to active the wireless inter-vehicle communication module 135.

One or more display 140 is connected to internal parts of the vehicle by a connecting member. The one or more display 140 could be set on the driving platform of the vehicle and in front of the driver but will not cause the visibility barrier of the diver. The operation interface 130 could be set on the platform or attached on the steering wheel of the vehicle 10a. In one embodiment the connecting member for connecting the display to the main body of the vehicle may be a hinged structure that allows the display to be folded at any desired angle, or a universal joint structure that allows the display to be rotated three dimensionally, freely. The display 140 could be LCD display panel, PDP (plasma display panel) and organic electroluminescence (OLED,) display panel. Other type of display could be used such as FED display panel.

In addition, the display 140 is rotatable and connected to the main body of the vehicle 10a, so that the display 140 may be placed in a position that is easily viewable to the driver regardless of user position. Furthermore, the display 140 may display the rearview image in response to the operating of the rearview image sensor 110. Therefore, the rearview image sensor 110 may catch the image and send it to the display 140 regardless of the moisture or fog situation. Furthermore, the display 140 may be the OLED or FED that could be formed on the windshield of the vehicle.

The rearview (or front view) image sensors 110 could be set around the convention rearview mirror location, or they may replace the traditional rearview mirror location. It means that the rearview image sensors 110 are attached front portion of the front door adjacent to the front door glass. Preferably, a motor driver is coupled to the rearview image sensors 110 for allowing the user to adjust the direction and angle of the rearview image sensors 110. It could be adjusted to a suitable position to monitor the condition of the blind-spot areas 14 and 15.

The wireless inter-vehicle (vehicle to vehicle) communication module 135 has communication functions and capability to communicate with others vehicles around or surrounding the user vehicle. The safety system may be employed for exchange audio, text and/or video data with others vehicles. In addition, it may transmit and receive image data, etc. through a packet transmission facility to a remote terminal. Further, it may display the current geographical position of the vehicle by GPS device 510 in the cars. The operation interface includes a button 130c to active the wireless inter-vehicle communication module 135.

The system according to this embodiment uses storage medium 125 so that the user may access to the desired image data in the storage medium 125. Next, the operation of the image sensor constructed in the aforementioned manner will be described hereinafter. All of the sensors according to this embodiment switch imaging between still and motion picture images based on the duration of time for which the shutter button 130a is pressed down. For example, the CPU or GPU drives the image sensor to obtain a still image and store it on the storage medium 125. In normal operation, the CPU or GPU drives the CCD or CMOS sensor to start obtaining motion picture image data and display it on the display, and/or store it on the storage medium 125 depending on the demand of the user.

The rear rearview image sensor 300 is similar to the side rearview image sensor. It is used to provide rear view of the vehicle and used to perform (or replace) the function of the conventional internal rearview mirror. Various locations near the rear of the vehicle 10a including the trunk lid, the tailgate, the bumper, a rear portion of the roof may all be desirable locations for the sensors 300.

The vehicle 10a also includes at least two side warning sensors 200 attached on the side body of the vehicle to monitor the traffic situation of the blind spots 102. As aforementioned, the blind spots 102 are the areas beyond which the conventional external rear-view mirrors cannot see without requiring the driver to glance back. In one embodiment, the sensors comprise radar, IR detector, a CCD (charge couple device imaging means) or CMOS image sensor for detecting or imaging a still or motion picture image and are coupled to the processor 120.

The side warning sensors 200 receive proximity information from blind spots 102. A top view of the sensors 200 is illustrated in FIG. 4. Both sensors 200 are embodied as active or passive. If the sensor 200 is passive, it could be radar to detect the nearby vehicle in the blind spots area 102. In active case, the sensor could be an image sensor 200. The switch of the turn signal light is coupled to the image sensor 200, when the driver turns on the switch to turn on the turn signal for the purpose of, for example, changing lane or turning right or left, the switch will simultaneously active the side warning sensors 200 to shoot the view of the blind spots area 102 to allow the driver may check the traffic situation.

The image taken by the side warning sensors 200 could be sent to the display on real time. Alternatively, the side warning sensors 200 could be power on during the driving operation. The sensors 200 make use of image capturing capability or reflection signal changes when target vehicles pass within close proximity of the vehicle. The changes are received in the controller to determine the properties of the target vehicle's motion. In one embodiment, the sensors comprise radar, IR detector, a CCD or CMOS image sensor for detecting or imaging a still or motion picture image and are coupled to the processor 120.

The blind-spot warning sensor 200 provides an indication to the vehicle driver as to the entering of a target vehicle within at least one of the blind-spots. The present system includes a vehicle bus for receiving various vehicle control signals, when the sensor receives proximity information. The sensors 200 sense object or vehicle that is approaching the vehicle 10a on the passenger side and eventually entering into one of the blind-spots. The vehicle 10a includes two side sensors 200 having respective fields of view. The fields of view may not overlap or may slightly overlap blind-spots. Therefore, the present invention also monitors the transition from the sensor fields of view to the blind-spots. Current technology allows small sensors to be placed inconspicuously on rear panels of the vehicle so as not to become aesthetically displeasing. Various locations near the rear of the vehicle 10a including the trunk lid, the tailgate, the bumper, an area above the tires, an area within vehicle side panels, or a rear portion of the roof may all be desirable locations for the sensors 200.

Referring now to FIG. 4, a block diagram of the system is illustrated. The system includes an external front (view image) sensor 400 according to one of the embodiments. In one embodiment, the front sensor comprise radar, IR detector, a CCD or CMOS image sensor for detecting or imaging a still or motion picture image and are coupled to the processor 120. The storage medium 125 may store still or motion picture image data obtained by the imaging sensor 400. The operation interface 130 further comprises a night vision mode button 130c to active night vision mode, such as IR mode, of the front view image sensors 400 for providing better night vision. The display (or warning device) 140 is also coupled to the front (view image) sensors 400 to issue an alarm signal when an object is detected within a predetermined range.

Each one of the aforementioned sensor and the storage medium may record the digital motion picture or still image. It may provide the evidences of fact when traffic accidence occurs, and it could be employed as the “vehicle accidence black box” due to the system records the detail of what happen. A buffer having sufficient capacity for storing the motion picture image data is provided between the sensors and the storage means, and the motion picture data obtained by the sensors is stored on the storage means through the buffer. The CPU or GPU 120 is adapted to drive CCD or CMOS sensor to initiate imaging a motion picture image and store the data in the buffer from the time when the shutter button 130a is pressed down. As was mentioned, the system includes the sensors for detecting or imaging blind spot areas 102, 14 and 15, rear view, side view and front image and proximity information. The vehicle bus receives various vehicle control signals and the controller 120 processes signals from the vehicle bus and the sensors.

The CPU or GPU 120 is adapted to drive at four sides CCD or CMOS sensor to initiate imaging a motion picture image and store the data in the buffer. The system includes the sensors for imaging rear view, left-side view, right-side view, and front image. The vehicle bus receives various vehicle control signals and the controller 120 processes signals from the vehicle bus and the sensors. The four side views may be composition by a panoramic image module 600A and the GPU 120, followed by generating the panoramic image and displaying the panoramic image on the display.

Please refer to FIG. 5 of the present invention, anyone who opens the door without authority or breaks into the vehicle illegally, the controller 120 will be active to control a panoramic image generating module 600A to create a panoramic image or video by at least four aforementioned image sensors, followed by displaying the panoramic image or video on the display 140. Preferably, an eye sensor 510 is coupled to the controller 120. The pressure sensor 510 may sensor the change of the eye (pupil) image of the vehicle driver. When the pupil change detected by the sensor 510 exceeds over a threshold, the sensor 510 will send a signal to the controller 120. The changes are received in the controller 120 to determine the situation of lane change. For instant, if the driver checks the rearview mirror for a time threshold (for example, over 1 second), it means that the driver would like to change the lane, the safety system will turn on the turning signal light corresponding to the rear mirror which side the driver looks at. The sensor 510 is effective. The controller 120 implements advanced algorithms for processing signals from the vehicle bus and the sensors. The controller 120 is preferably a microprocessor-based controller having a central processing unit, internal memory, and associated inputs and outputs communicating across the bus. The controller 120 may include various processing units which may be incorporated as separate devices or as an integral part of the controller. The warning system 600 is in responsive to the sensor 510 to issue a warning alarm.

As aforementioned, the present invention may detect the traffic condition including the blind spots area 102, 14, 15, front object for the driver. The vehicle interface or vehicle warning interface receives signals from the controller 120 and activates vehicle pre-crash warning systems 600 including, for example, audible warnings from the speaker, visual warnings or voice warnings before crash from a pre-crash warning system. All of the sensors including the rear view sensor, side view sensor, burglarproof sensor and the front view sensor include a night vision mode for operation in low light or darkness environment.

The eye detecting sensor may be replaced or incorporated with EEG (electroencephalograph), Electromyographic (EMG) system. The warning system could be controlled and through the measurement of the electrical activity of the human brain. The EEG (electroencephalograph) records the voltage fluctuations of the brain which can be detected using electrodes attached to the scalp. The EEG signals arise from the cerebral cortex, a layer of highly convoluted neuronal tissue several centimeters thick. Alpha waves (8-13 Hz) that can be created if the user concentrates on simple mentally isolated actions like closing one's eyes; Beta waves (14-30 Hz) associated with an alert state of mind; Theta waves (4-7 Hz) usually associated with the beginning of sleep state by frustration or disappointment; and Delta waves (below 3.5 Hz) associated with deep sleep. Electromyographic (EMG) sensors are attached to the person's skin to sense and translate muscular impulses to control computer functions. Patients have been reported to have moved objects on computer screens via EMG sensed tensing and untensing of facial muscles. Also, Electrooculargraphic (EOG) signals have been sensed from eye movement. The neural activity is tracked on neural activity detecting device 350. Preferably, the neural activity tracked includes EEQ EOG EMG activity. The electrical signals representative of the neural activity are transmitted via wired or wireless to the control unit. If a predetermined signal is sensed by detecting device 510, the same EEG readings may be monitored. For example, the Theta wave (3.5-7 Hz.) is detected, it refers to the state of sleep. Thus, if the sleep pattern is detected, the warning system is responsive to the signal and issue an alarm to awake up the driver. It should be noted that the sleep patterns of potential users may be monitored before the system is used. The monitoring of and response to the user's facial expressions may also be used, for example, the closure of user's eyes could be monitored with a still camera or a video camera. These implementations could be in response to a signal that the user has passed into sleep.

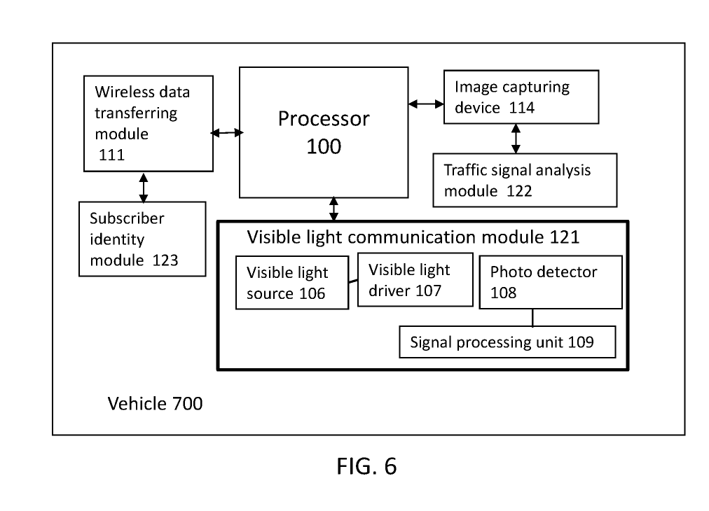

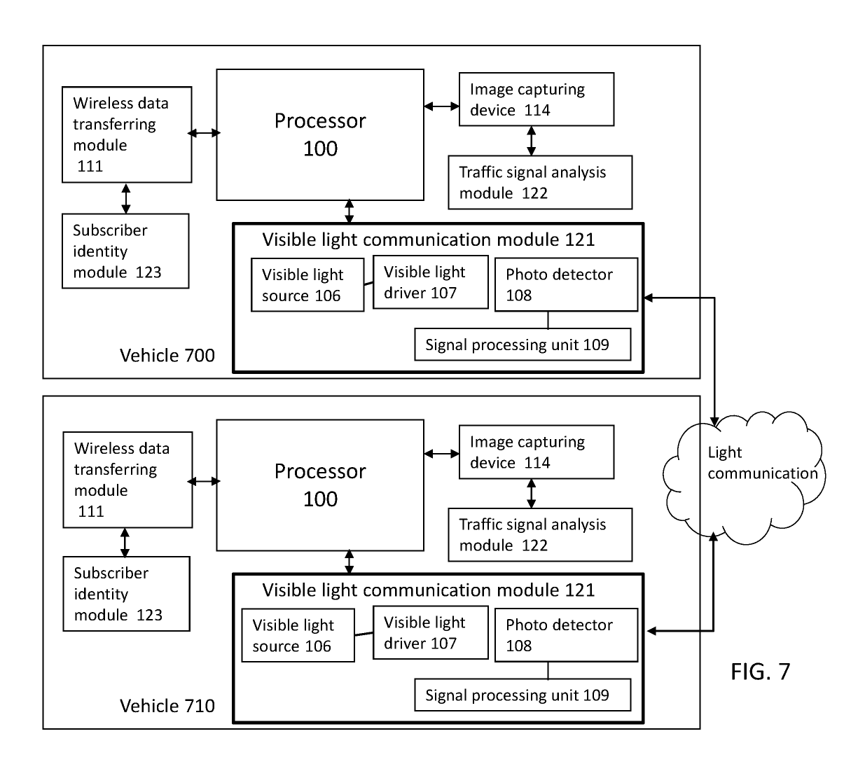

As mentioned previously described, some or all of the components in the portable communication device 10 may be embedded in, coupled to or incorporated in a vehicle, a traffic signal light device, a street light device or a roadway light device. As shown in FIG. 6, the vehicle 700 at least includes a control unit or processor 100, an image capturing device 114 coupled to the processor 100 to capture a traffic signal image, a traffic signal analysis module 122 coupled to the image capturing device 114 to analyze the traffic signal image, a wireless data transferring module 111 coupled to the processor 100, a subscriber identity module 123 coupled to the wireless data transferring module 111, and a visible light communication device (module) 121. For example, the traffic signal analysis module 122 is used to analyze the traffic signal image for providing latest traffic information for strategic road network, road conditions, traffic's vehicle accident, or any traffic information. Other components depicted in FIG. 1 may be included in the vehicle 700. The wireless data transferring module is 5G (5th generation mobile networks or 5th generation wireless systems) or higher level standard compatible module. The visible light source device 106 of the vehicle 700 can stream data embedded in its light beams at ultra-high speed to the photo detector 108 of another vehicle 710, shown in FIG. 7. Similarly, the LEDs device 106 of the vehicle 710 can stream data embedded in its light beams at ultra-high speed to the photo detector 108 of another vehicle 710, shown in FIG. 7. Namely, the photo detector 108 of the vehicle 700 may receive the data from other vehicle 710. Thus, the vehicle 700 can exchange data with the vehicle 710 by the light fidelity module 121. The photo detector 108 converts light signals into voltage or current. For example, the photo detector 108 of the vehicle 710 is converting the tiny change in amplitude of the light beams into an electrical current signal, and then converting back into a data stream by the signal amplification and processing unit 109. There is a method of parallel data transmission using array of LEDs, where each LED transmits a different data stream. Another method is using mixtures of red, green and blue LED (or OLED, field emission light source, laser) to alter the light's frequency, with each frequency encoding a different data channel. The visible light source of the first vehicle may be configured to transmit a visible light to another vehicle, wherein the visible light source mix at least two colors of light to transmit multiple data streams at different color frequencies. The mixed light source of the first vehicle is configured to transmit light to another vehicle, wherein the mixed light source includes three color frequencies, and the mixed light source mix at least two colors frequencies to transmit multiple data streams at different color frequencies. The invention may mix the at least colors of red (R), green (G), blue (B), RG, GB, RB, RGB to achieve multiple data stream with different frequencies. In the invention, the visible light source mix at least two colors of light to transmit multiple data streams at different color frequencies, and a digital code processing unit is used to encode or decode the multiple data streams. The mixed data stream is created by mixing different color with different color frequencies. Based on the aforementioned, in the present application, the mixing at least two colors of light, such as RG, RB, GB, RGB, can be created to simultaneously transmit at least four data streams. If the primary color is introduced, the present invention can offer seven data streams. It provides better transmission efficiency. Such advancements promise a theoretical speed of 1 Gbps, which means one can download a full high-definition film in just 30 seconds.

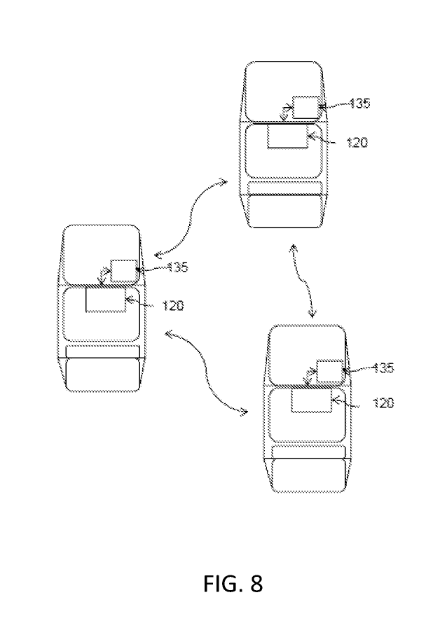

In one example, the pluralities of inter-vehicle wireless communication module 135 of several vehicles with visible light communication device (module) 121 construct a vehicular ad-hoc network, please refer to FIG. 8. The vehicular ad hoc networks or inter-vehicle communication network are created by applying the principles of mobile ad hoc networks for the spontaneous creation of a wireless network for data exchange to the domain of vehicles. In one embodiment, the vehicular ad hoc networks or inter-vehicle communication network could employ the LTE (Long Term Evolution) protocol or others 5th generation mobile networks or 5th generation wireless systems. In addition to providing simply faster speeds, 5G networks meet the need of the internet of vehicles. It provides vehicle-to-vehicle communications to provide road safety, navigation, and other roadside services.

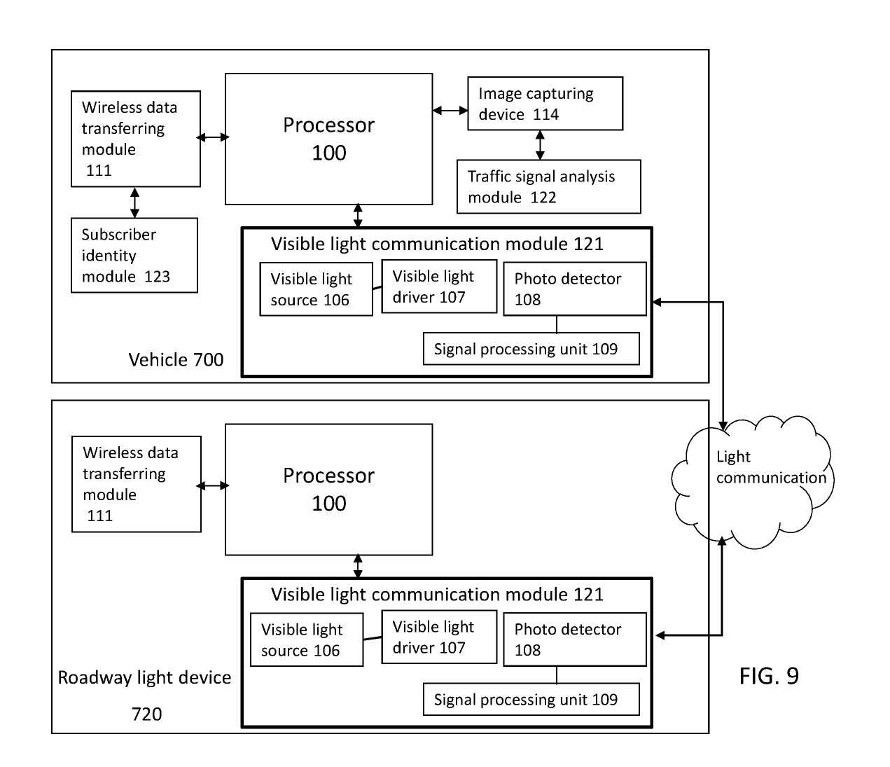

In another embodiment, some or all of the components in the portable communication device 10 may be embedded in, coupled to or incorporated in a roadway light device. The visible light source device 106 of the vehicle 700 can stream data embedded in its light beams at ultra-high speed to the photo detector 108 of a roadway light device (module) 720 with visible light communication device (module) 121, shown in FIG. 9. Similarly, the LEDs device 106 of the roadway light device 720 can stream data embedded in its light beams at ultra-high speed to the photo detector 108 of the vehicle 700, shown in FIG. 9. Namely, the photo detector 108 of the vehicle 700 may receive the data from the roadway light device 720. Thus, the vehicle 700 can exchange data with the roadway light device 720 by the light fidelity module 121. The parallel data transmission and mixed light source transmission may be used.

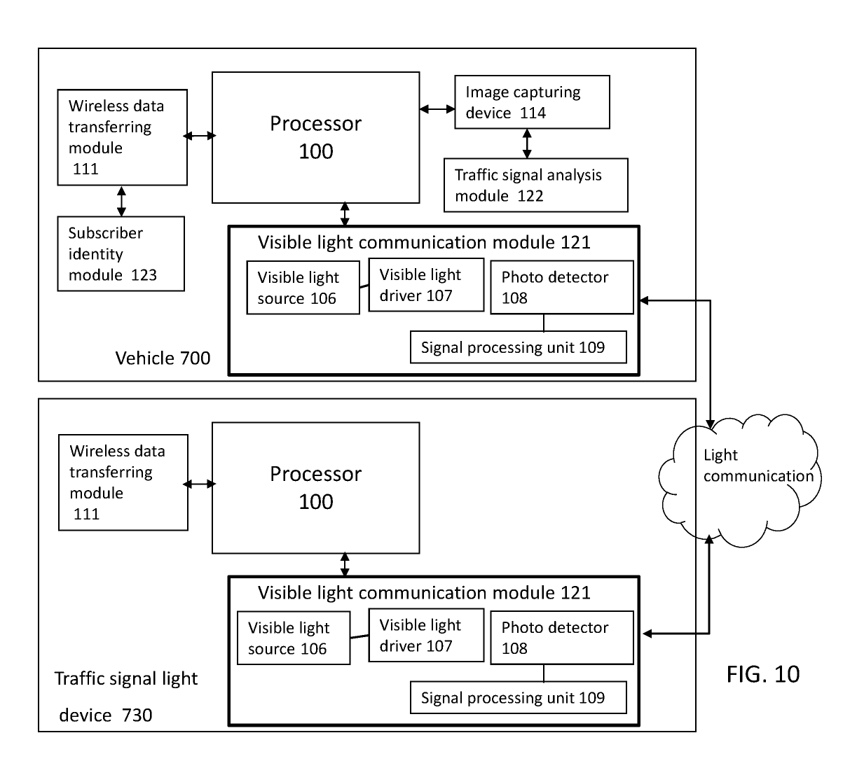

In one embodiment, some or all of the components in the portable communication device 10 may be embedded in, coupled to or incorporated in a traffic signal light device. The visible light source device 106 of the vehicle 700 can stream data embedded in its light beams at ultra-high speed to the photo detector 108 of a traffic signal light device (module) 730 with visible light communication device (module) 121, shown in FIG. 10. Similarly, the LEDs device 106 of the traffic signal light device 730 can stream data embedded in its light beams at ultra-high speed to the photo detector 108 of the vehicle 700, shown in FIG. 10. Namely, the photo detector 108 of the vehicle 700 may receive the data from the traffic signal light device 730. Thus, the vehicle 700 can exchange data with the traffic signal light device 730 by the light fidelity module 121. The parallel data transmission and mixed light source transmission may be used.

It will be understood that the above descriptions of embodiments are given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of this invention.

What is claimed is:

1. A vehicle, comprising:
a visible light source to transmit a first visible light to another vehicle;
a photo detector configured to receive a second visible light transmitted from said another vehicle; and
a digital code processing unit configured to encode said first visible light or decode said second visible light.

2. The vehicle as set forth in claim 1, wherein said visible light source includes LED, OLED, field emission or laser device.

3. The vehicle as set forth in claim 1, further comprising a signal amplification and processing unit.

4. The vehicle as set forth in claim 1, further comprising a display coupled to a control unit.

5. The vehicle as set forth in claim 1, further comprising an image capturing device coupled to a control unit to capture a traffic signal image, and a traffic signal analysis module coupled to said image capturing device to analyze said traffic signal image.

6. The vehicle as set forth in claim 1, further comprising a visible light driver to drive said visible light source.

7. The vehicle as set forth in claim 1, further comprising a wireless data transferring module coupled to a control unit, and a subscriber identity module coupled to said wireless data transferring module.

8. The vehicle as set forth in claim 7, wherein said wireless data transferring module is 5G or higher level standard compatible module.

9. The vehicle as set forth in claim 1, further comprising a transceiver coupled to a control unit.

10. A vehicle, comprising:
a first visible light source to transmit a first visible light to another vehicle;
a roadway light photo detector configured to receive a second visible light transmitted from a roadway light device with a second visible light source; and
a digital code processing unit configured to encode said first visible light or decode said second visible light.

11. The vehicle as set forth in claim 10, further comprising an image capturing device coupled to a control unit to capture a traffic signal image, and a traffic signal analysis module coupled to said image capturing device to analyze said traffic signal image.

12. The vehicle as set forth in claim 10, further comprising a visible light driver to drive said first visible light source.

13. The vehicle as set forth in claim 10, further comprising a wireless data transferring module coupled to a control unit, and a subscriber identity module coupled to said wireless data transferring module.

14. The vehicle as set forth in claim 10, wherein said wireless data transferring module is 5G or higher level standard compatible module.

15. A vehicle, comprising:
a first visible light source to transmit a first visible light to another vehicle;
a traffic signal photo detector configured to receive a second visible light transmitted from a traffic signal light device with a second visible light source; and
a digital code processing unit configured to encode said first visible light or decode said second visible light.

16. The vehicle as set forth in claim 15, further comprising an image capturing device coupled to a control unit to capture a traffic signal image, and a traffic signal analysis module coupled to said image capturing device to analyze said traffic signal image.

17. The vehicle as set forth in claim 15, further comprising a visible light driver to drive said first visible light source.

18. The vehicle as set forth in claim 15, further comprising a wireless data transferring module coupled to a control unit, and a subscriber identity module coupled to said wireless data transferring module.

19. The vehicle as set forth in claim 15, wherein said wireless data transferring module is 5G or higher level standard compatible module.

20. The vehicle as set forth in claim 15, further comprising a display coupled to a control unit.
